(19) United States
(12) Patent Application Publication
(10) Pub. No.: US 2012/0311375 A1
(43) Pub. Date: Dec. 6, 2012

(54) REDIRECTING REQUESTS TO SECONDARY LOCATION DURING TEMPORARY OUTAGE

(75) Inventors: Siddharth Rajendra Shah, Bothell, WA (US); Jeffrey McDowell, Redmond, WA (US); Viktoriya Taranov, Bellevue, WA (US); Daniel Blood, Snohomish, WA (US)

(73) Assignee: MICROSOFT CORPORATION, Redmond, WA (US)

(21) Appl. No.: 13/151,092

(22) Filed: Jun. 1, 2011

(51) Int. Cl. G06F 11/20

(52) U.S. Cl. 714/4.11; 714/E11.073

(57) ABSTRACT

During an outage at a primary location for an online service that is temporary in duration (e.g. a “temporary outage”), requests are temporarily switched from the primary location to a secondary location for the online service. The temporary outage may be caused by many different reasons (e.g. power outage, planned maintenance, and the like). The secondary location may be configured as read only during the temporary outage such that users are still able to access their data during the temporary without causing changes to be made to the data. The requests to the primary location of the online service are automatically redirected to be handled by the secondary location. When the temporary outage ends, the requests are automatically switched back to the primary location.

### BACKGROUND

Web-based applications include files that are located on web servers along with data that is stored in databases. For example, there may be a large number of servers to handle the traffic that is directed to a network service. These networks often have unreliable communications as well as computers and software that are unreliable that may lead to a failure of the network service. A fail-over transition process to address the failure is an expensive operation to complete and can take a long period of time.

### SUMMARY

This Summary is provided to introduce a selection of concepts in a simplified form that are further described below in the Detailed Description. This Summary is not intended to identify key features or essential features of the claimed subject matter, nor is it intended to be used as an aid in determining the scope of the claimed subject matter.

During an outage at a primary location for an online service that is temporary in duration (e.g. a “temporary outage”), requests are temporarily switched from the primary location to a secondary location for the online service. The temporary outage may be caused by many different reasons (e.g. power outage, planned maintenance, and the like). The secondary location may be configured as read only during the temporary outage such that users are still able to access their data during the temporary without causing changes to be made to the data. The requests to the primary location of the online service are automatically redirected to be handled by the secondary location. When the temporary outage ends, the requests are automatically switched back to the primary location.

### BRIEF DESCRIPTION OF THE DRAWINGS

FIG. 1 illustrates an exemplary computing environment;

FIG. 2 shows a system for redirecting requests to a secondary location of an online service during a temporary outage;

FIG. 3 illustrates a process for configuring the redirecting of requests to a secondary location during a temporary outage; and

FIG. 4 shows a process for processing a request received during a temporary outage.

### DETAILED DESCRIPTION

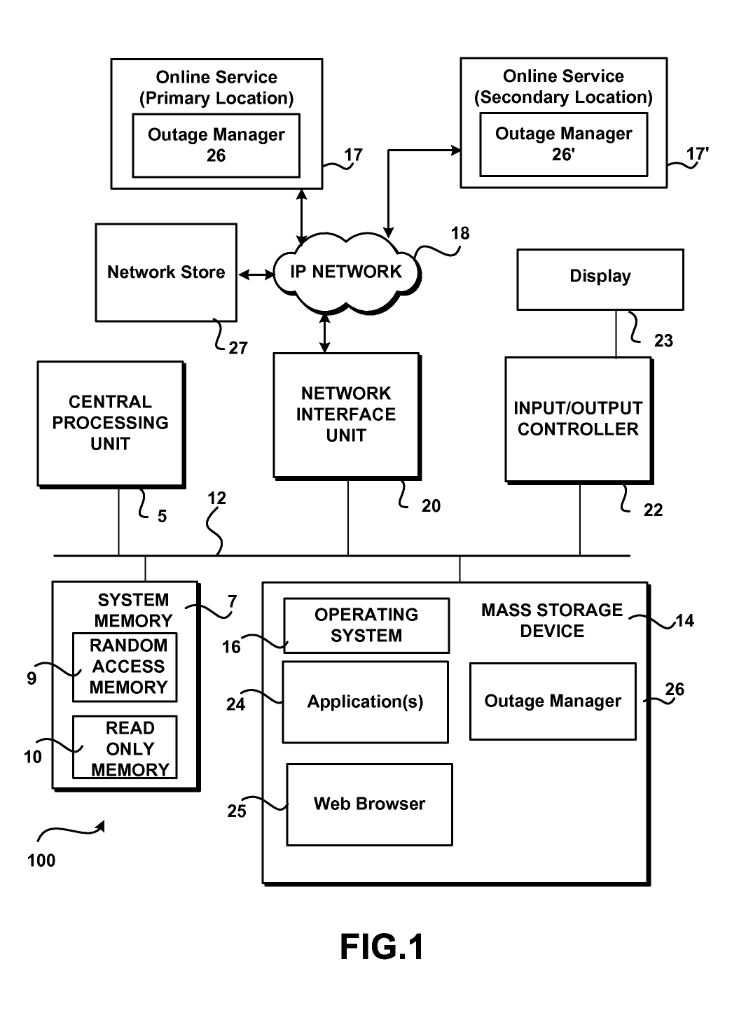

Referring now to the drawings, in which like numerals represent like elements, various embodiment will be described. In particular, FIG. 1 and the corresponding discussion are intended to provide a brief, general description of a suitable computing environment in which embodiments may be implemented.

Generally, program modules include routines, programs, components, data structures, and other types of structures that perform particular tasks or implement particular abstract data types. Other computer system configurations may also be used, including hand-held devices, multiprocessor systems, microprocessor-based or programmable consumer electronics, minicomputers, mainframe computers, and the like. Distributed computing environments may also be used where tasks are performed by remote processing devices that are linked through a communications network. In a distributed computing environment, program modules may be located in both local and remote memory storage devices.

Referring now to FIG. 1, an illustrative computer environment for a computer 100 utilized in the various embodiments will be described. The computer environment shown in FIG. 1 includes computing devices that each may be configured as a mobile computing device (e.g. phone, tablet, net book, laptop), server, a desktop, or some other type of computing device and includes a central processing unit 5 (“CPU”), a system memory 7, including a random access memory 9 (“RAM”) and a read-only memory (“ROM”) 10, and a system bus 12 that couples the memory to the central processing unit (“CPU”) 5.

A basic input/output system containing the basic routines that help to transfer information between elements within the computer, such as during startup, is stored in the ROM 10. The computer 100 further includes a mass storage device 14 for storing an operating system 16, application(s) 24, Web browser 25, and outage manager 26 which will be described in greater detail below.

The mass storage device 14 is connected to the CPU 5 through a mass storage controller (not shown) connected to the bus 12. The mass storage device 14 and its associated computer-readable media provide non-volatile storage for the computer 100. Although the description of computer-readable media contained herein refers to a mass storage device, such as a hard disk or CD-ROM drive, the computer-readable media can be any available media that can be accessed by the computer 100.

By way of example, and not limitation, computer-readable media may comprise computer storage media and communication media. Computer storage media includes volatile and non-volatile, removable and non-removable media implemented in any method or technology for storage of information such as computer-readable instructions, data structures, program modules or other data. Computer storage media includes, but is not limited to, RAM, ROM, Erasable Programmable Read Only Memory (“EPROM”), Electrically Erasable Programmable Read Only Memory (“EEPROM”), flash memory or other solid state memory technology, CD-ROM, digital versatile disks (“DVD”), or other optical storage, magnetic cassettes, magnetic tape, magnetic disk storage or other magnetic storage devices, or any other medium which can be used to store the desired information and which can be accessed by the computer 100.

Computer 100 operates in a networked environment using logical connections to remote computers through a network 18, such as the Internet. The computer 100 may connect to the network 18 through a network interface unit 20 connected to the bus 12. The network connection may be wireless and/or wired. The network interface unit 20 may also be utilized to connect to other types of networks and remote computer systems. The computer 100 may also include an input/output controller 22 for receiving and processing input from a number of other devices, including a keyboard, mouse, or electronic stylus (not shown in FIG. 1). Similarly, an input/output controller 22 may provide input/output to a display screen 23, a printer, or other type of output device.

As mentioned briefly above, a number of program modules and data files may be stored in the mass storage device 14 and RAM 9 of the computer 100, including an operating system 16 suitable for controlling the operation of a computer, such as the WINDOWS 7®, WINDOWS SERVER®, or WINDOWS PHONE 7® operating system from MICROSOFT CORPORATION of Redmond, Washington. The mass storage device 14 and RAM 9 may also store one or more program modules. In particular, the mass storage device 14 and the RAM 9 may store one or more application programs, including one or more application(s) 24 and Web browser 25. According to an embodiment, application 24 is an application that is configured to interact with on online service, such as a business point of solution service that provides services for different tenants. Other applications may also be used. For example, application 24 may be a client application that is configured to interact with data. The application may be configured to interact with many different types of data, including but not limited to: documents, spreadsheets, slides, notes, and the like.

Network store 27 is configured to store data such as tenant data for tenants. Network store 27 is accessible to one or more computing devices/users through IP network 18. For example, network store 27 may store tenant data for one or more tenants for an online service, such as online service 17. Other network stores may also be configured to store data for tenants. Tenant data may also move from on network store to another network store. As illustrated, the online service includes a primary location 17 and a secondary location 17′. According to an embodiment, the secondary location 17′ is a mirror of the primary online service 17. Generally, the secondary location 17′ provides a copy of the services and data that are provided by the primary online service 17. During normal operation, requests to the online service are directed to the primary location 17. While the primary location is active, content changes and actions that occur in the primary network are mirrored in the secondary location. In this way, the primary location and the secondary location remain configured in the same manner and include the same content.

Outage manager 26 is configured to automatically redirect requests that are directed to the primary location of the online service to the secondary location of the online service during a temporary outage. Outage manager 26 may be a part of an online service, such as online service 17, and all/some of the functionality provided by outage manager 26 may be located internally/externally from an application.

During an outage that affects the primary location 17 that is temporary in duration (e.g. a “temporary outage”), user requests are temporarily switched from the primary location 17 to the secondary location 17′ of the online service. The time length of a temporary outage may be different lengths (e.g. ten minutes, thirty minutes, one hour, two hours, and the like). Generally, a temporary outage is an outage that is believed to be resolvable within some known duration of time. The temporary outage may be caused by many different reasons (e.g. power outage, planned maintenance, and the like). According to an embodiment, the secondary location 17′ is configured as read only during the temporary outage such that users are able to still access their data at the second location during the time period of the temporary outage. During the temporary outage, requests to the online service are redirected to the secondary location by changing a DNS entry (Domain Name System) that redirects requests to the network address of the secondary location of the online service. When the temporary outage is resolved, the requests are automatically switched back to the primary network by changing back the DNS entry to address the primary location. More details regarding the outage manager are disclosed below.

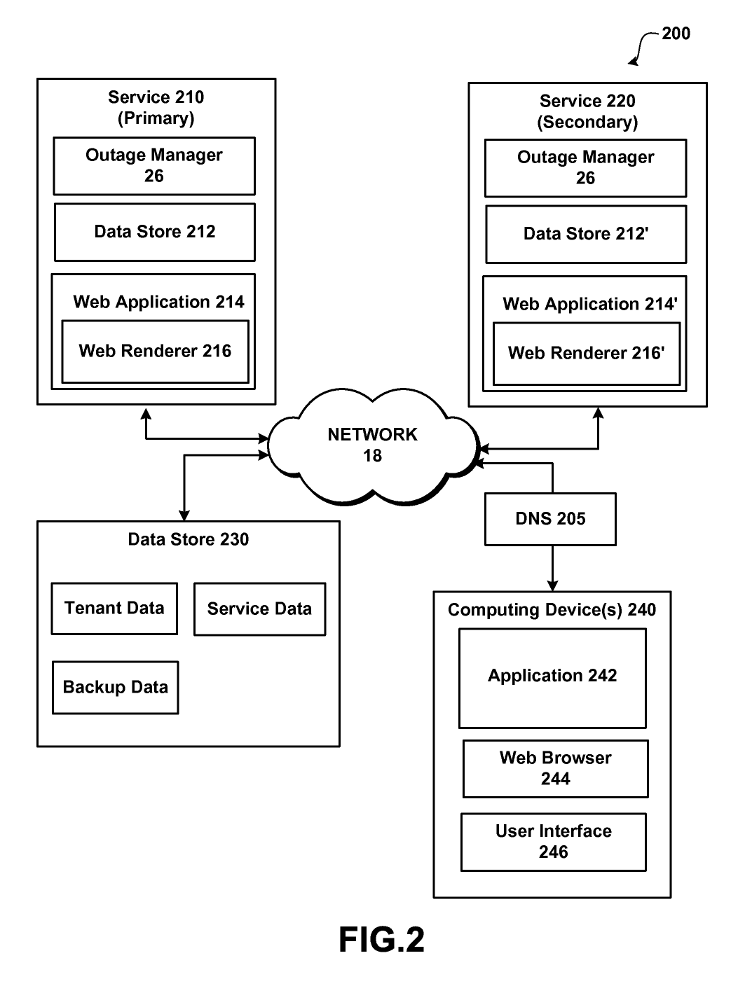

FIG. 2 shows a system for redirecting requests to a secondary location of an online service during a temporary outage. As illustrated, system 200 includes primary service 210, secondary service 220, data store 230 and computing device(s) 240.

The computing devices used may be any type of computing device that is configured to perform the operations relating to the use of the computing device. For example, some of the computing devices may be: mobile computing devices (e.g. cellular phones, tablets, smart phones, laptops, and the like); some may be desktop computing devices and other computing devices may be configured as servers. Some computing devices may be arranged to provide an online cloud based service (e.g. service 210 and service 220), some may be arranged as data shares that provide data storage services, some may be arranged in local networks, some may be arranged in networks accessible through the Internet, and the like.

The computing devices are coupled through network 18. Network 18 may be many different types of networks. For example, network 18 may be an IP network, a carrier network for cellular communications, and the like. Generally, network 18 is used to transmit data between computing devices, such as service 210, service 220, data store 230 and computing device(s) 240.

Computing device(s) 240 includes application 242, Web browser 244 and user interface 246. As illustrated, computing device 240 is used by a user to interact with an online service, such as service 210. According to an embodiment, service 210 and 220 is a multi-tenancy service. Generally, multi-tenancy refers to the isolation of data (including backups), usage and administration between customers. In other words, data from one customer (tenant 1) is not accessible by another customer (tenant 2) even though the data from each of the tenants may be stored within a same database within the same data store.

User interface (UI) 246 is used to interact with various applications that may be local/non-local to computing device 240. One or more user interfaces of one or more types may be used to interact with content. For example, UI 246 may include the use of a context menu, a menu within a menu bar, a menu item selected from a ribbon user interface, a graphical menu, and the like. Generally, UI 246 is configured such that a user may easily interact with functionality of an application. For example, a user may simply select an option within UI 246 to perform an operation such as retrieving content that is maintained by service 210.

Data store 230 is configured to store tenant data. The data stores are accessible by various computing devices. For example, the network stores may be associated with an online service that supports online business point of solution services. For example, an online service may provide data services, word processing services, spreadsheet services, and the like.

As illustrated, data store 230 includes tenant data, including corresponding backup data, for N different tenants. A data store may store all/portion of a tenant's data. For example, some tenants may use more than one data store, whereas other tenants share the data store with many other tenants. While the corresponding backup data for a tenant is illustrated within the same data store, the backup data may be stored at other locations. For example, one data store may be used to store tenant data and one or more other data stores may be used to store the corresponding backup data. Data store 230 may also include data relating to operation of the service (e.g. service 210, service 220). One or more data stores may also be stored within a network of an online service (e.g. data store 212 for primary service 210 and data store 212′ for secondary service 220). Generally, the data in data store 212′ is a mirror of the data in data store 212. Changes made to data that is associated with the primary service 210 (i.e. data relating to administrative changes and tenant data) is mirrored to the secondary service 220. According to an embodiment, full backups (e.g. weekly), incremental backups (e.g. hourly, daily) and transaction logs are used in maintaining the changes made. According to an embodiment, the changes made to the primary service are copied to the secondary service such that the secondary service remains substantially synchronized with the primary service (e.g. within five, ten minutes). Periodically, the data that is copied to the secondary service is verified to help ensure that the data has been correctly copied. Different methods may be used to perform the verification (e.g. checksums, hash functions, and the like).

Services 210 and 220 include data store 212 and 212′ and Web application 214 and 214′ that comprises Web renderer 216 and 216′. Service 210 is configured as an online service that is configured to provide services relating to displaying an interacting with data from multiple tenants. Service 210 provides a shared infrastructure for multiple tenants. According to an embodiment, the service 210 is MICROSOFT'S SHAREPOINT ONLINE service. Different tenants may host their Web applications/site collections using service 210. A tenant may also use a dedicated alone or in combination with the services provided by service 210. Web application 214 is configured for receiving and responding to requests relating to data. For example, service 210 may access a tenant's data that is stored on data store 212 and/or data store 230. Web application 214 is operative to provide an interface to a user of a computing device, such as computing device 240, to interact with data accessible via network 18. Web application 214 may communicate with other servers that are used for performing operations relating to the service. A computing device may transmit a request to interact with a document, and/or other data that is associated with service 210.

DNS 205 provides an address of the service to computing device 240 that is used to access the service. When a temporary outage is occurring, DNS 205 provides the address of the secondary service 220 such that the request to the online service from computing device 240 may still be serviced with little or no interruption in access to the user's data. Upon detection of the temporary outage (or at a scheduled time in case of a known temporary outage and/or planned event), outage manager 26 (or some other authorized user) switches the entry for the primary service 210 to address the secondary service 220 during the time period of the temporary outage.

In response to receiving a request at a service, Web application 214 obtains the data from a location, such as network share 230 and/or some other data store. The data to display is converted into a markup language format, such as the ISO/IEC 29500 format. The data may be converted by service 210 or by one or more other computing devices. Once the Web application 214 has received the markup language representation of the data, the service utilizes the Web renderer 216 to convert the markup language formatted document into a representation of the data that may be rendered by a Web browser application, such as Web browser 244 on computing device 240. The rendered data appears substantially similar to the output of a corresponding desktop application when utilized to view the same data. Once Web renderer 216 has completed rendering the file, it is returned by the service 210 to the requesting computing device where it may be rendered by the Web browser 244.

The Web renderer 216 is also configured to render into the markup language file one or more scripts for allowing the user of a computing device, such as computing device 240 to interact with the data within the context of the Web browser 244. Web renderer 216 is operative to render script code that is executable by the Web browser application 244 into the returned Web page. The scripts may provide functionality, for instance, for allowing a user to change a section of the data and/or to modify values that are related to the data. In response to certain types of user input, the scripts may be executed. When a script is executed, a response may be transmitted to the service 210 indicating that the document has been acted upon, to identify the type of interaction that was made, and to further identify to the Web application 214 the function that should be performed upon the data.

According to an embodiment, the secondary service 220 remains active in a read only mode even when it is not receiving requests such that the secondary service is readily available to service requests when a temporary outage occurs and requests are automatically directed to the secondary service.

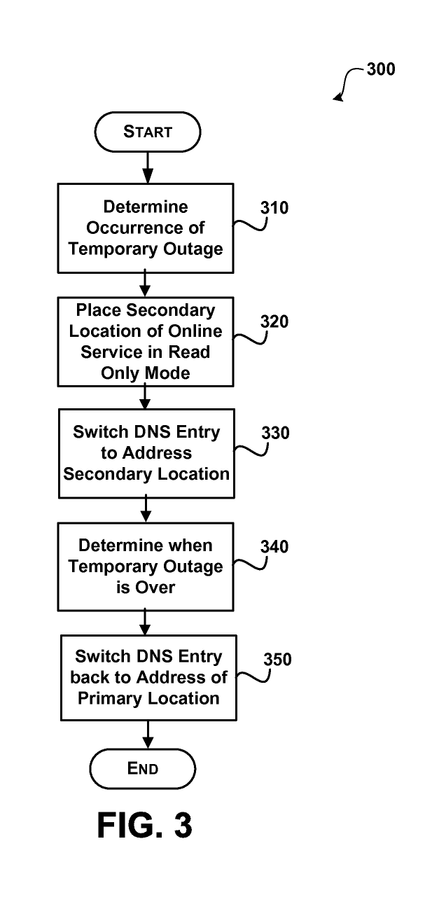

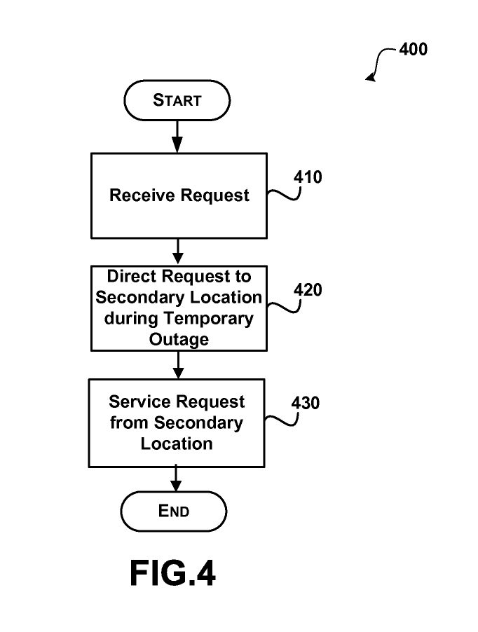

FIGS. 3 and 4 show an illustrative process for temporarily redirecting requests to a secondary location during a temporary outage. When reading the discussion of the routines presented herein, it should be appreciated that the logical operations of various embodiments are implemented (1) as a sequence of computer implemented acts or program modules running on a computing system and/or (2) as interconnected machine logic circuits or circuit modules within the computing system. The implementation is a matter of choice dependent on the performance requirements of the computing system implementing the invention. Accordingly, the logical operations illustrated and making up the embodiments described herein are referred to variously as operations, structural devices, acts or modules. These operations, structural devices, acts and modules may be implemented in software, in firmware, in special purpose digital logic, and any combination thereof.

FIG. 3 illustrates a process for configuring the redirecting of requests to a secondary location during a temporary outage.

After a start block, process 300 moves to operation 310, where a determination is made as to when a temporary outage occurs. The temporary outage may be a planned occurrence and/or an unplanned occurrence. For example, it may be known that a power outage will occur at a specific time and last some estimated period of time. Similarly, a planned outage may be scheduled in order to perform maintenance at the primary location. In some cases, a temporary outage may occur at the primary location that is not considered a full failure. For example, a thunderstorm may temporarily affect the power at the primary location but it is expected that the power will be restored before some period of time (e.g. 1 hour, 2 hours, . . . ).

Flowing to operation 320, the secondary location of the online service may be placed into read only mode and/or may already be in a read only mode. According to an embodiment, the secondary location is not placed in read only mode. Placing the secondary location in read only mode during the temporary outage helps to ensure that the primary location remains mirrored to the secondary location during the period of time of the temporary outage. A user may still access their content that was in the primary location from the secondary location during the temporary outage. A small portion of content may not be initially available at the secondary location if there was not enough time to either copy over recent changes made to the primary location (e.g. the last five or ten minutes of content changes made to the primary location) or to apply the changes to the secondary location. In some cases, the content will have been copied to the secondary location before the temporary outage but not yet applied. In this situation, the secondary location may continue to have the content updated during the temporary outage such that the secondary location mirrors the primary location after a few minutes (e.g. five, ten minutes),

Moving to operation 330, the DNS entry for the primary location is switched to address the secondary location. Switching the DNS entry from the primary location to the secondary location is a fast operation that may appear seamless to an end user.

Transitioning to operation 340, a determination is made as to when the temporary outage is over. The determination may be made based different factors (e.g. when the primary location comes back online, when a predetermined scheduled time occurs, and/or when an authorized user indicates the primary location is available).

Moving to operation 350, the DNS entry is switched back to the primary location. The user may now access all of their content (read/write) without having experienced a significant disruption of the online service. When the secondary location is placed in read only mode during the temporary outage, there are no changes to be made to the primary location. As such, the primary location resumes service as if there was no temporary outage.

The process then flows to an end block and returns to processing other actions.

FIG. 4 shows a process for processing a request received during a temporary outage.

After a start block, the process moves to operation 410 where a request is received that is directed to an online service.

Flowing to operation 420, the received request is directed to the secondary location during the period of time of the temporary outage. The received request is automatically directed to the secondary location such that a client of the online service accesses the secondary location as if it were the primary location.

Moving to operation 430, the request is serviced by the secondary location instead of the primary location during the time of the temporary outage. According to an embodiment, the secondary location is placed in a read only mode such that the client is able to read all of their content but not change the content.

The process then flows to an end block and returns to processing other actions.

The above specification, examples and data provide a complete description of the manufacture and use of the composition of the invention. Since many embodiments of the invention can be made without departing from the spirit and scope of the invention, the invention resides in the claims hereinafter appended.

What is claimed is:

1. A method for redirecting requests from a primary location to a secondary location during a temporary outage, comprising:
determining when a temporary outage occurs that affects a primary location of an online service;
receiving a request to access the online service during the temporary outage; and
redirecting the request to access a secondary location instead of the primary location of the online service during the temporary outage.

2. The method of claim 1, wherein redirecting the request to access the secondary location instead of the primary location of the online service during the temporary outage comprises changing a DNS (Domain Name System) entry from a primary network address to a secondary network address of the secondary location for the online service.

3. The method of claim 1, further comprising placing the secondary location of the online service in read only mode and continuing to update the secondary location with content obtained from the primary service before the temporary outage.

4. The method of claim 1, wherein determining when the temporary outage occurs comprises determining when planned maintenance is to occur that affects access to the primary location of the online service.

5. The method of claim 1, wherein determining when the temporary outage occurs comprises determining when a power outage is to occur that affects access to the primary location of the online service.

6. The method of claim 1, further comprising determining when the temporary outage ends and the primary location of the online service becomes available again.

7. The method of claim 1, wherein the secondary location of the online service is substantially a mirror of the primary location of the online service, wherein the secondary location substantially comprises content of the primary location and remains accessible before and after the temporary outage.

8. The method of claim 1, further comprising updating the secondary location with changes made to the primary location periodically throughout a day.

9. The method of claim 8, further comprising ensuring that the changes made to the primary location are reflected in the secondary location.

10. A computer-readable storage medium storing computer-executable instructions for redirecting requests from a primary location to a secondary location during a temporary outage, comprising:
determining when a temporary outage occurs that affects a primary location of an online service;
receiving a request to access the online service during the temporary outage;
redirecting the request to access a secondary location instead of the primary location of the online service during the temporary outage; and
directing the request to access the primary location when the temporary outage is over.

11. The computer-readable storage medium of claim 10, further comprising changing a DNS (Domain Name System) entry from a primary network address of the primary location to a secondary network address of the secondary location for the online service in response to determining when the temporary outage occurs.

12. The computer-readable storage medium of claim 10, further comprising placing the secondary location of the online service in read only mode such that content of the secondary location remains unchanged during the temporary outage.

13. The computer-readable storage medium of claim 10, wherein determining when the temporary outage occurs comprises determining when a planned event is to occur that affects access to the primary location of the online service.

14. The computer-readable storage medium of claim 10, wherein determining when the temporary outage occurs comprises determining when a power outage is to occur that affects access to the primary location of the online service for a period of time that is not planned on exceeding a predetermined time period.

15. The computer-readable storage medium of claim 10, wherein the secondary location of the online service is substantially a mirror of the primary location of the online service, wherein the secondary location substantially comprises content of the primary location and remains accessible before and after the temporary outage.

16. The computer-readable storage medium of claim 10, further comprising updating the secondary location with changes made to the primary location periodically throughout a day and ensuring that the changes made to the primary location are reflected in the secondary location.

17. A system for redirecting requests from a primary location to a secondary location during a temporary outage, comprising:
a network connection that is configured to connect to a network;
a processor, memory, and a computer-readable storage medium;
an operating environment stored on the computer-readable storage medium and executing on the processor;
a data store storing tenant data that is associated with different tenants; and
an outage manager operating that is configured to perform actions comprising:
determining when a temporary outage occurs that affects a primary location of an online service;
receiving a request to access the online service during the temporary outage;
redirecting the request to access a secondary location instead of the primary location of the online service during the temporary outage; and
directing the request to access the primary location when the temporary outage is over.

18. The system of claim 17, further comprising changing a DNS (Domain Name System) entry from a primary network address of the primary location to a secondary network address of the secondary location for the online service in response to determining when the temporary outage occurs.

19. The system of claim 17, further comprising placing the secondary location of the online service in read only mode such that content of the secondary location remains unchanged during the temporary outage.

20. The system of claim 17, wherein the secondary location of the online service is substantially a mirror of the primary location of the online service, wherein the secondary location substantially comprises content of the primary location and remains accessible before and after the temporary outage.
